(19) United States
(12) Patent Application Publication
(10) Pub. No.: US 2007/0142938 A1
(43) Pub. Date: Jun. 21, 2007

(54) Programmable logic controller having power frequency carrier

(75) Inventor: Yuan-Yu Huang, Taipei City (TW)

Correspondence Address: TROXELL LAW OFFICE PLLC, 5205 LEESBURG PIKE, SUITE 1404, FALLS CHURCH, VA, 22041, US

(73) Assignee: HANSDER ENGINEERING CO., LTD, Taipei City (TW)

(21) Appl. No.: 11/634,237

(22) Filed: Dec. 6, 2006

(30) Foreign Application Priority Data
Dec. 15, 2005 (CN) 200520144819.1

(51) Int. Cl. G05B 13/02

(52) U.S. Cl. 700/40

(57) ABSTRACT

The present invention integrates electronical devices for switching any of the devices on or off as one wish easily through an indoor power circuit by using a programmable logic controller.

### FIELD OF THE INVENTION

The present invention reIates to a PLC (programmabIe logic controller); more particularly, relates to integrating the switching on or off of any of electroncal devices through power frequency carrier.

### DESCRIPTION OF THE RELATED ARTS

A general electronical device 5 is used by plugging its power line 51 in an indoor socket to obtain an outside electricity for the electronical device 5 to run (as shown in FIG. 4). When a user wants to switch on or off the electronical device 5, push bottoms 521 on a control panel 52 is used to turn it on or turn it off.

The electronical device 5 can be turned on or off by using push bottoms 521; yet, there are usually a few electronical devices in use in a house; so, when the user is leaving, he might only turn off those electronical devices 5 at hand and forget to turn off remote electronical devices 5 in use. Thus, electricity might be wasted.

Consequently, a specific extended power line 6 is invented, where the extended power line 6 comprises several sockets 61 and each socket 61 has its own on /off bottom 62 (as shown in FIG. 5) and each electronical device is plugged in its own socket 61. When a user does not need to use an electronical device any more, the on/off bottom 62 on the extended power line 6 for the electronical device is used to turn the electronical device off. Nevertheless, because the sockets 61 of the extended power line 6 are linked serially, when one of the sockets 61 is damaged, the whole extended power line 6 is spoiled. In addition, when the sockets 61 of the extended power line 6 are fully plugged with electronical devices, the voltage may be overloaded and the extended power line 6 may be burned. Hence, the prior arts do not fulfill users' requests on actual use.

### SUMMARY OF THE INVENTION The main purpose of the present invention is to integrate the switching on or off of any of electronical devices through an indoor power unit by using a PLC.

To achieve the above purpose, the present invention is a PLC having power frequency carrier, comprising a PLC, a converter and an indoor power unit, where the PLC comprises a central processing unit, a memory, an output module and an input module; the converter comprises a single-chip control module, a power carrier module, an output module and an input module; the indoor power unit is connected with the output module of the PLC and the input module of the converter; and the output module of the converter is connected with the input module of the PLC. Accordingly, a novel PLC having power frequency carrier is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is a fundamental frame view according to a preferred embodiment of the present invention;

FIG. 2 is a block view according to the preferred embodiment of the present invention;

FIG. 3 is a block view showing a state of use according to the preferred embodiment of the present invention;

FIG. 4 is a view of an electronical device of a prior art; and

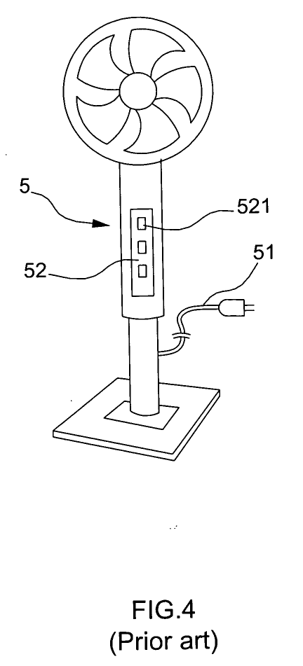

FIG. 5 is a view of an extended power line of a prior art.

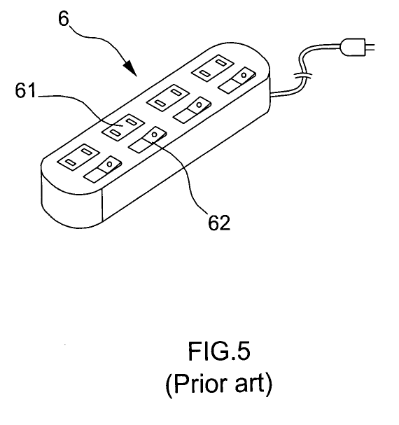

### DESCRIPTION OF THE PREFERRED EMBODIMENT

The following description of the preferred embodiment is provided to understand the features and the structures of the present invention.

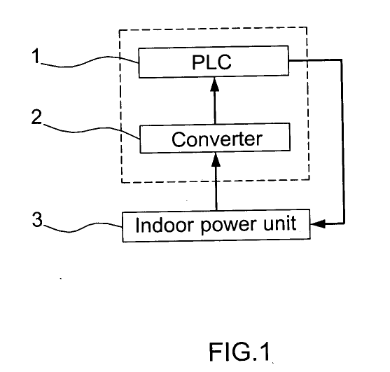

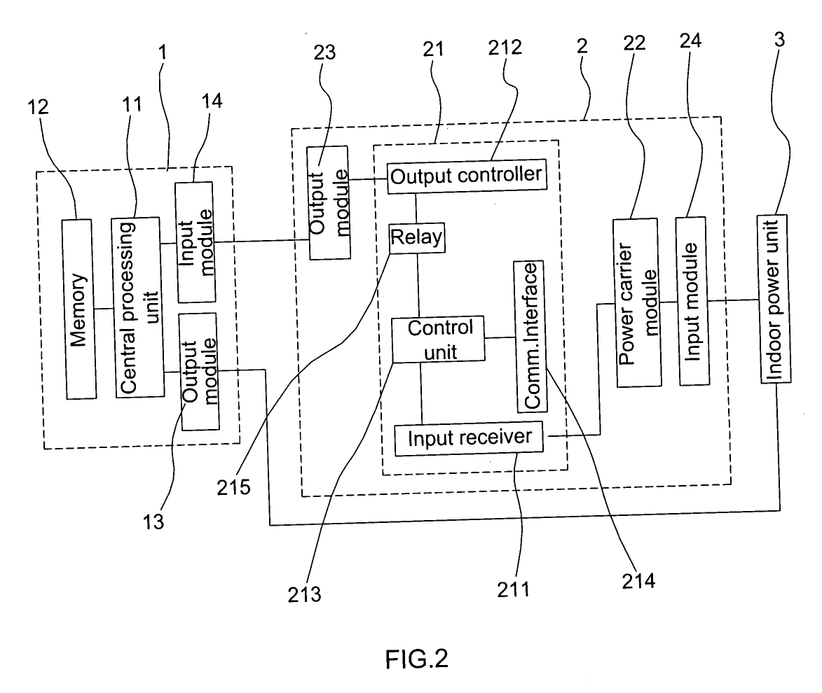

Please refer to FIG. 1 and FIG. 2, which are a fundamental frame view and a block view according to a preferred embodiment of the present invention. As shown in the figures, the present invention is a PLC (programmable logic controller) having power frequency carrier, comprising a PLC 1, a converter 2 and an indoor power unit 3, where, by using the PLC 1, the indoor power unit 3 controls and integrates the switch-on/off functions of all electronical devices.

The PLC 1 comprises a central processing unit 11, a memory 12, an output module 13 and an input module 14 where the central processing unit 11 is connected with the memory 12, the output module 13 and the input module 14. By using the programmable memory 12, commands for specific functions are stored within the programmable memory 12 to operate logic calculations, sortings, clockings, computations, etc.

The converter 2 comprises a single-chip control module 21, a power carrier module 22 with a transmission rate of 1200 BPS, an output module 23 and an input module 24; and the output module 23 is connected with the input module 14 of the PLC. Therein, the single-chip control module 21 comprises an input receiver 211, an output controller 212, a control unit 213, a communiation interface 214 and a relay 215. The control unit 213 is a 8051 single-chip as a processing unit having excellent inner structure with a working frequency up to 16 MHz, comprising a 4 k size of electrically programmable and erasable ROM (Read Only Memory), and eight input pins and eight output pins. The relay 215 is located at the output pins to quarantine the circuit for securing and ensuring the operation of the single-chip control module 21. The 8051 single chip of the control module 21 contains a full-duplex communication interface 214 inside. The communication interface 214 can be an RS232 interface to transfer and receive data simultaneously from outside. Because the operational signals are on a TTL (transistor-transistor-logic) level (0 voltage set as logic 0; +5 voltage set as logic 1) and the communication interface 214 is a serial one to transfer or receive data in a form of series of bits, linkages can be easily established between controllers (such as absorbing carrier, auto-detecting device, etc.) apparatuses and computers.

The indoor power unit 3 is a socket of indoor electrical circuit for connecting the output module 13 of the PLC and the input module 24 of the converter 2.

Thus, a PLC having power frequency carrier is obtained.

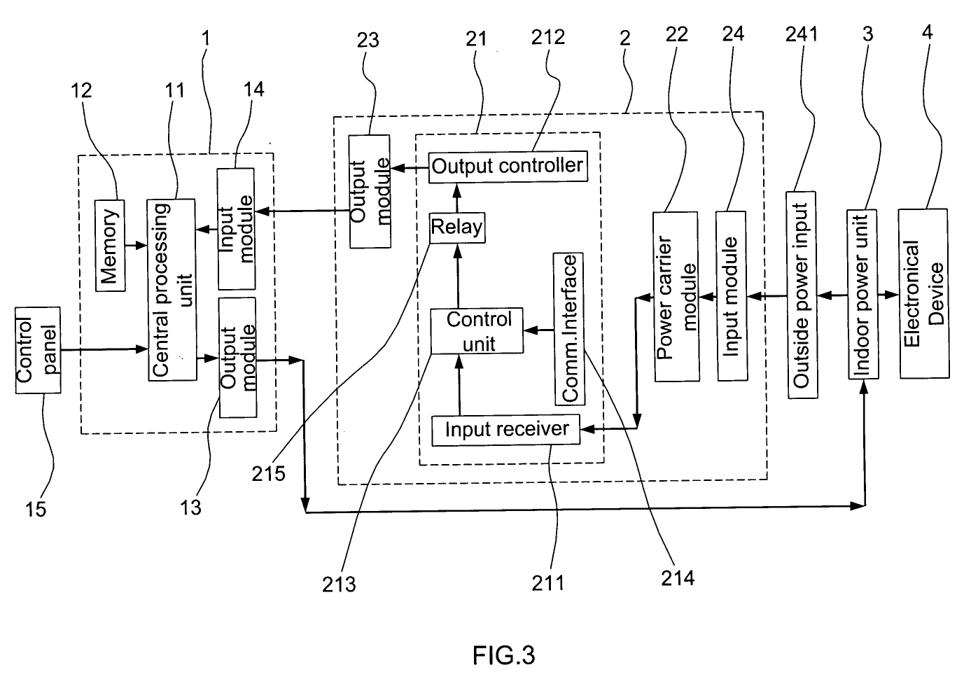

Please refer to FIG. 3, which is a block view showing a state of use according to the preferred embodiment of the present invention. As shown in the figure, when using the present invention, an outside power input 241 of an in put module 24 of a converter 2 is set to connect with an indoor power unit 3; and, a plurality of electronical devices 4 is connected with the indoor power unit 3; in another word, the electronical devices 4 are plugged in sockets of an indoor power circuit. By doing so, a circuit is formed with a PLC (programmable logic controller) 1 together with the converter 2 and the indoor power unit 3. Besides, a required control procedure can be inputted into a memory 12 of the PLC 1 in advance.

When a user connected the outside power input 241 with the indoor power unit 3, an electricity is transmitted from the indoor power unit 3 to be received by the converter 2. As the converter 2 receives the electricity transmitted from the indoor power unit 3, the electricity is then transmitted to a power carrier module 22 through the in put module 24 of the converter 2 to be modulated; and, after the modulation, signals in the electricity are transmitted to an input receiver 211 of a single-chip control module 21. After the outputted signals are received by the input receiver 211, the signals are transmitted to an output controller 212 through a control unit 213 and a relay 215. Then, the signals are transmitted to an output module 23 by using the output controller 212. As a result, the signals enter into a central processing unit 11 from the input module 24 of the PLC 1. When the user wants to switch on/off any of the electronical devices 4, only a switch-on/off signal is required from a control panel 15 to be inputted into the central processing unit 11; then, the signal is transmitted to the indoor power unit 3 by an output module 13 of the PLC to switch on/off the electronical device 4. Hence it is achieved that the indoor power unit 3 coordinated with the PLC 1 integrates the switch-on/off functions of all electronical devices.

To sum up, the present invention is a PLC having power frequency carrier, where, by using a PLC through an indoor power unit, the indoor electronical devices can be switched on/off in an integrated way.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A PLC (programmable logic controller) having power frequency carrier, comprising:
(a) a PLC comprising a central processing unit, a memory, an output module and an input module, said central processing unit connecting to said memory, said output module and said input module;
(b) a converter comprising a single-chip control module, a power carrier module, an output module and an input module, said output module connecting to said input module of said PLC; and
(c) an indoor power unit connecting to said output module of said PLC, said indoor power unit connecting to said input module of said converter.

2. The PLC according to claim 1, wherein said input module of said converter is connected with an outside power input.

3. The PLC according to claim 1, wherein said single-chip control module comprises an input receiver, an output controller, a control unit, a communication interface and a relay.

4. The PLC according to claim 1 wherein said control unit is a 8051 single-chip.

5. The PLC according to claim 1, wherein said control unit comprises a working frequency of 16 MHz.

6. The PLC according to claim 1, wherein said communication interface is an RS232 interface.

7. The PLC according to claim 1, wherein said power carrier module comprises a transmission rate of 1200 BPS (bits per second).

8. The PLC according to claim 1, wherein said indoor power unit is a socket for an indoor electricity circuit.
